(19) United States
(12) Patent Application Publication
(10) Pub. No.: US 2006/0015423 A1
(43) Pub. Date: Jan. 19, 2006

(54) Integrated method loan and financial planning system and method

(76) Inventor: Todd K. Ballenger, Chapel Hill, NC (US)

Correspondence Address: MACCORD MASON PLLC, 300 N. GREENE STREET, SUITE 1600, P. O. BOX 2974, GREENSBORO, NC, 27402, US

(21) Appl. No.: 10/890,752

(22) Filed: Jul. 14, 2004

(51) Int. Cl. G06Q 40/00

(52) U.S. Cl. 705/35

(57) ABSTRACT

An integrated mortgage loan and financial planning system for use by an integrated network of service providers within a predetermined community utilizing a shared, automatically-generated mortgage loan and financial planning application with a client's information for evaluation and approval by members of a network of service providers providing integrated mortgage loan and financial planning. Also, a system and method for providing a client's integrated mortgage loan and financial planning information to a network of financial service providers.

### BACKGROUND OF THE INVENTION

(1) Field of the Invention

The present invention relates generally to financial planning and, more particularly, to automated systems and methods for mortgage lending through financial advisors.

(2) Description of the Prior Art

Typically, prior art systems and methods for mortgage loan or financial planning include computer-assisted or computer-implemented programs for financial planning and/or advising, implementing a mortgage loan plan, and for personal financial planning. Additionally, some prior art references provide for determining an optimal investment plan for distressed residential real estate loans. Finally, financial modeling and counseling is provided for using automated systems and methods.

However, prior art systems and methods do not provide for an integrated system to integrate the mortgage loan into the overall financial plans of the consumer, i.e., the combination of component functions for financial planning and mortgage loan planning is not provided in such a way as to permit the integration and cooperation of the functions and provide a seamless presentation of the inputs, outputs, and/or analyses in a user-friendly, report-based manner for use by professional services providers and mortgage loan applicants as well.

Thus, there remains a need for integrated mortgage loan and financial planning systems and methods having automation and computer-assisted computation and analyses with corresponding report outputs for a multiplicity of users.

### SUMMARY OF THE INVENTION

The present invention is directed to automate the process of information such that the mortgage loan ties to financial planning systems and methods for use by an integrated network of service providers within a predetermined community.

Accordingly, one aspect of the present invention is to provide a computer-based scenario desk with a display having a user interface provided thereon that is viewable by at least one user for inputting input information and reviewing output information, the input information including a mortgage loan applicant's financial history, personal data, and status; the output information including a summary of the input information, current liabilities, recommended debt structure, asset accumulation, total real estate investment value, risk information and/or analyses, mortgage loan-related data, estimates and scenarios for mortgage loan structure, and notes.

Another aspect of the present invention is to provide a computer-based scenario desk with a display having a user interface provided thereon that is viewable by at least one user for inputting input information and reviewing output information, wherein the output information further includes diagrammatic or visual summary information relating to risk, target points, modeling, mortgage loan type advantages/disadvantages, and other relevant mortgage analyses information.

Still another aspect of the present invention is to provide methods for using the a computer-based scenario desk with a display having a user interface provided thereon that is viewable by at least one user for inputting input information and reviewing output information, including diagrammatic or visual summary information.

These and other aspects of the present invention will become apparent to those skilled in the art after a reading of the following description of the preferred embodiment when considered with the drawings.

### BRIEF DESCRIPTION OF THE DRAWINGS

FIG. 1 is a computer screen user interface view of a mortgage loan planning analysis cover page constructed according to the present invention.

FIG. 2 is a computer screen user interface view of tabular output information constructed according to the present invention.

FIG. 3 is a computer screen user interface view of tabular output information constructed according to the present invention.

FIG. 4 is a computer screen user interface view of diagrammatic output information constructed according to the present invention.

FIG. 5 is a computer screen user interface view of user input information prompts constructed according to the present invention.

FIG. 6 is a computer screen user interface view of tabular output information constructed according to the present invention.

FIG. 7 is a computer screen user interface view of diagrammatic output information constructed according to the present invention.

FIG. 8 is a computer screen user interface view of tabular output information constructed according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

A design example, not necessarily optimized, but illustrative of what can be done by a mortgage loan evaluation and financial planning system and method, are provided in the following description of the invention.

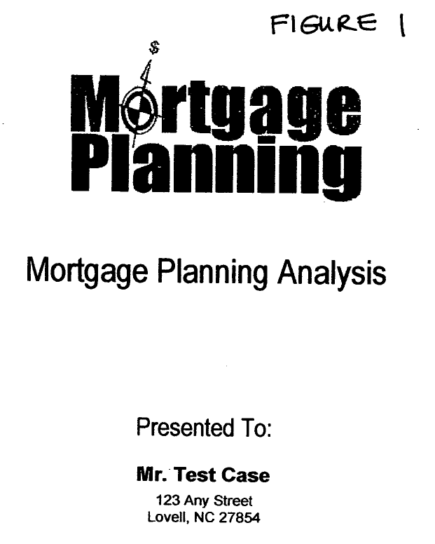

In a preferred embodiment of the present invention, as shown in FIGS. 1 through 8, described in the foregoing, an example of graphic user interfaces presenting information generated by applicant or user inputs for evaluating an applicant by the automated, integrated mortgage loan and financial planning systems and methods for use by an integrated network of service providers within a predetermined community. More particularly, the present invention, as shown in the example within FIGS. 1 through 8, provides a computer-based scenario desk with a display having a user interface provided thereon that is viewable by at least one user for inputting input information and reviewing output information, the input information including a mortgage loan applicant's financial history, personal data, and status; the output information including a summary of the input information, current liabilities, recommended debt structure, asset accumulation, total real estate investment value, risk information and/or analyses, mortgage loan-related data, estimates and scenarios for mortgage loan structure, and notes.

Furthermore, as illustrated in the FIGS. 1 through 8, the present invention provides a computer-based scenario desk with a display having a user interface provided thereon that is viewable by at least one user for inputting input information and reviewing output information, wherein the output information further includes diagrammatic or visual summary information relating to risk, target points, modeling, mortgage loan type advantages/ disadvantages, and other relevant mortgage loan analyses information.

Referring now to the drawings in general, the illustrations are for the purpose of describing a preferred embodiment of the invention and are not intended to limit the invention thereto. In a preferred embodiment, a multiplicity of interface views are provided to the at least one user of the system and method of the present invention.

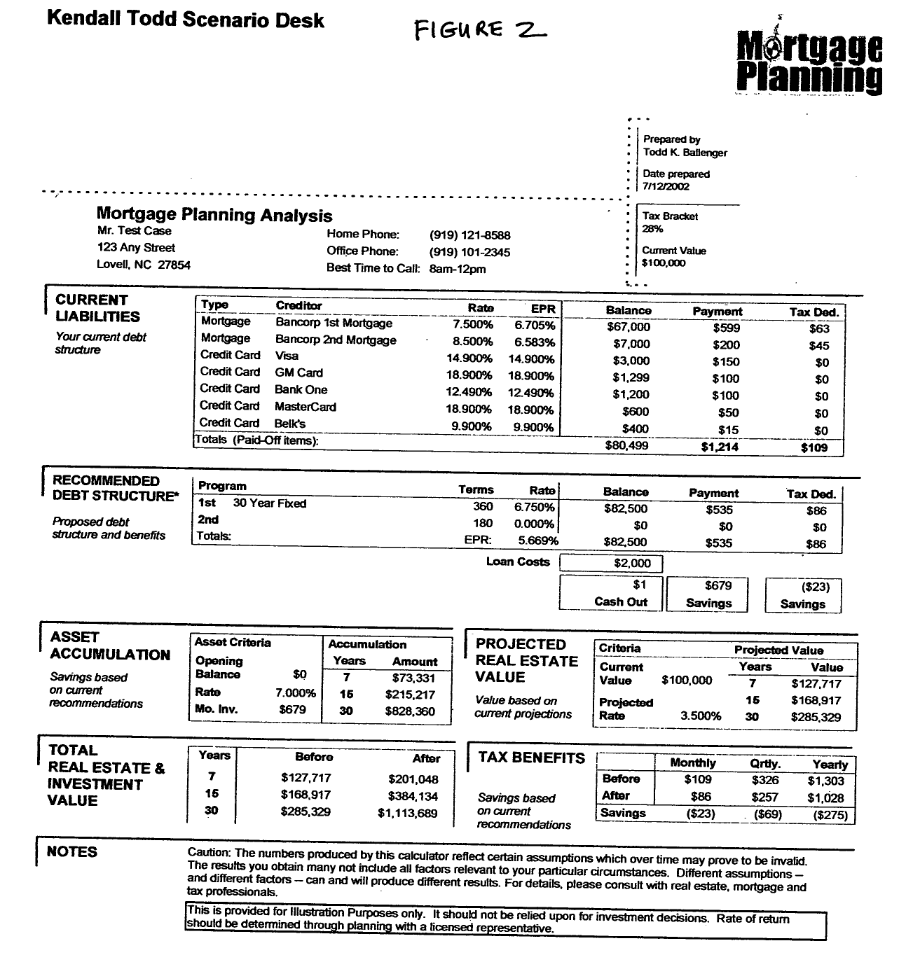

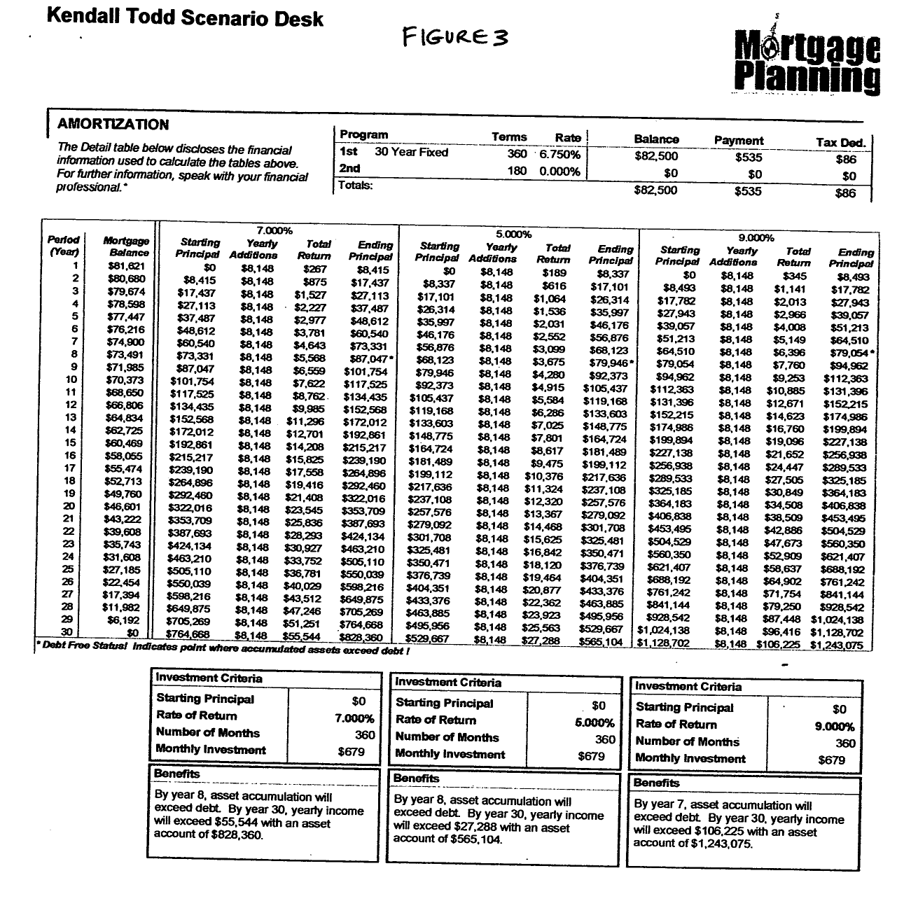

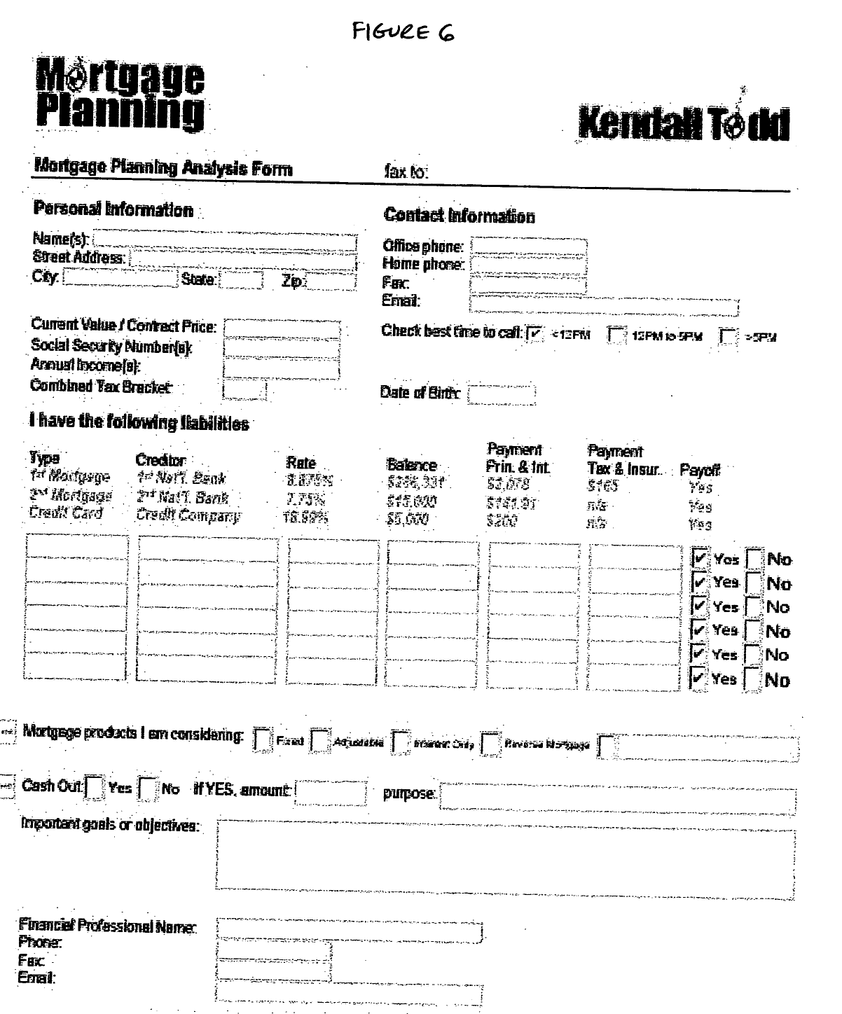

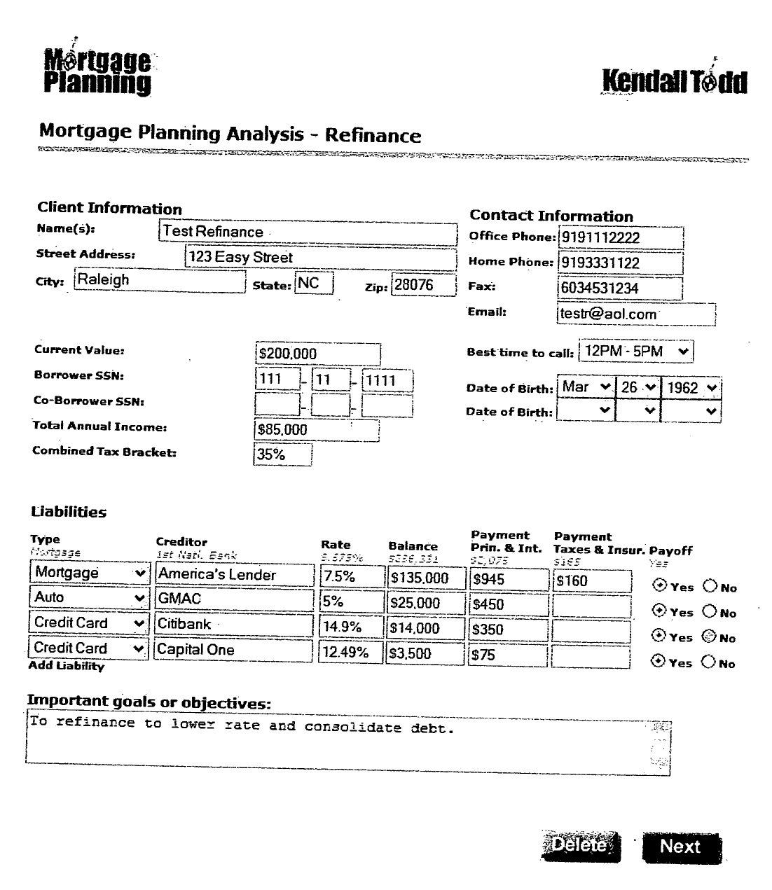

As best seen in FIG. 1, a computer screen user interface view of a mortgage loan planning analysis cover page constructed according to the present invention is shown. FIGS. 2, 3, 6, and 8 show a computer screen user interface view of tabular output information constructed according to the present invention. FIG. 2 shows a computer screen user interface view of tabular output information including a scenario desk layout further including a mortgage loan planning analysis page having output information components, including current liabilities, recommended debt structure, asset accumulation, total real estate investment value, projected real estate value, tax benefits, notes, and similar fields providing summaries of applicant input information, along with analyses and proposals for the applicant's and other users' consideration in the context of mortgage loan application review and approval. FIG. 3 is a computer screen user interface view of tabular output information including amortization schedule data for at least one mortgage loan program, such as a fixed or variable mortgage loan program for a predetermined number of years, the corresponding rate(s), balance(s), payment(s), and tax deduction(s) corresponding to each program shown. FIG. 6 is a computer screen user interface view of tabular output information constructed according to the present invention. FIG. 8 is a computer screen user interface view of tabular output information constructed according to the present invention.

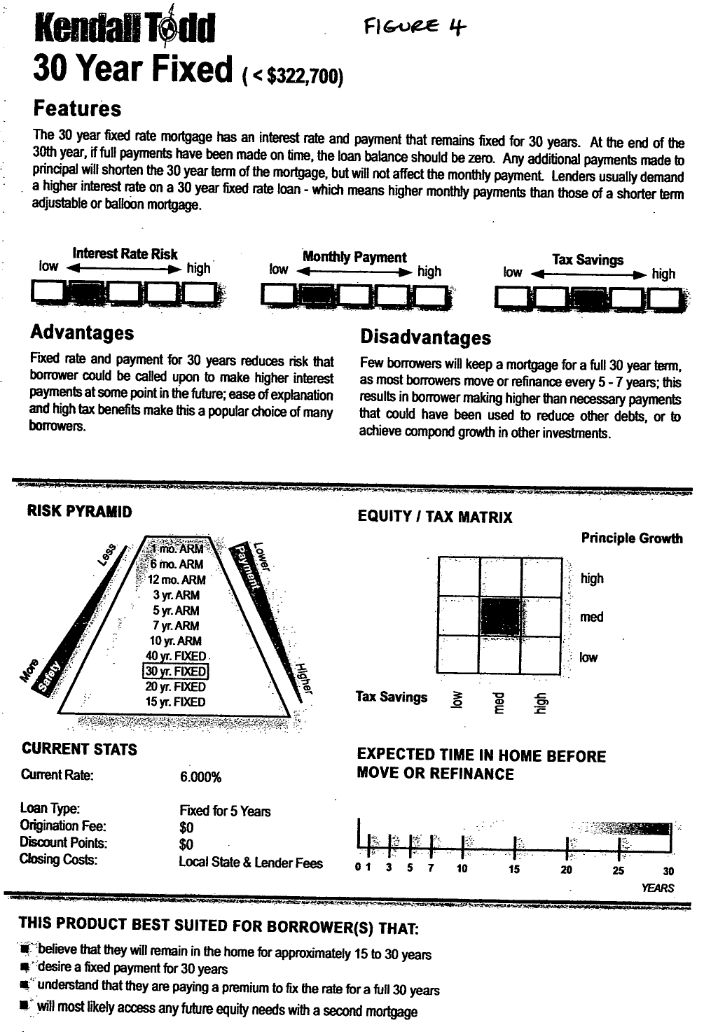

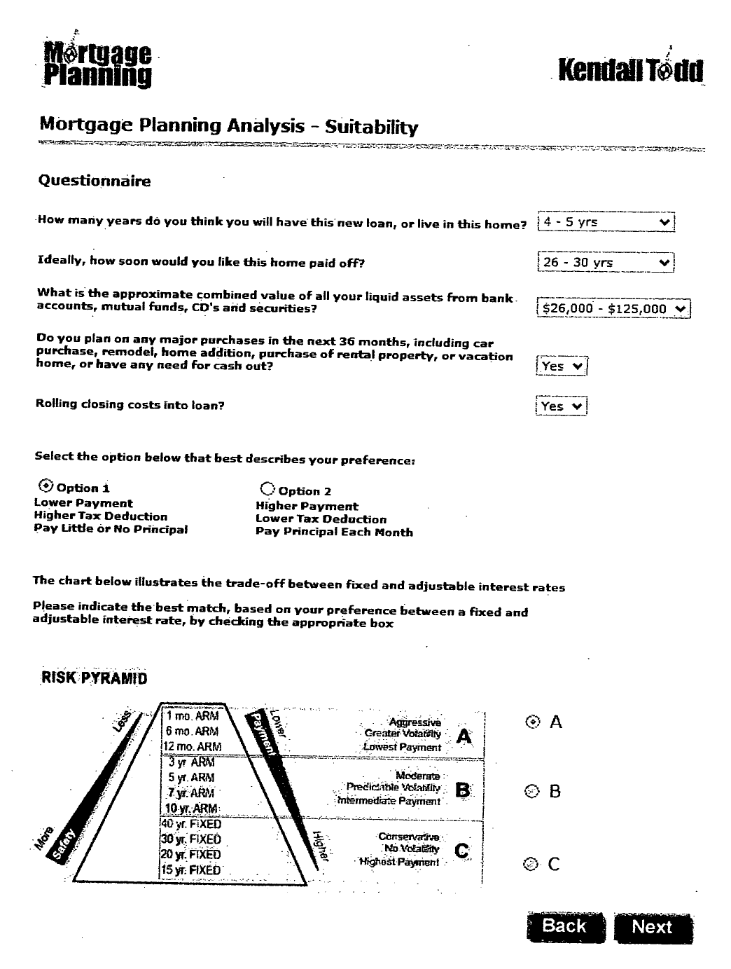

FIGS. 4 and 7 show a computer screen user interface view having diagrammatic output information constructed according to the present invention. FIG. 4 shows diagrammatic output information relating to advantages and disadvantages of the featured or selected type of mortgage loan shown in user interface and/or output; additionally, diagrammatic output information illustrating the level of risk or safety associated with different types of mortgage loans, e.g., fixed or variable for predetermined periods of time, including but not limited to 1 month ARM, 6 month ARM, 12 month ARM, 3 yr. ARM, 5 yr. ARM, 7 yr. ARM, 10 yr. ARM, 40 yr. FIXED, 30 yr. FIXED, 20 yr. FIXED, 15 yr. FIXED, etc. ranked in an order from low to high risk or high safety to lesser safety from the bottom to the top of the pyramid, with a 30 yr. FIXED rate mortgage loan selected, as indicated by the outlined option. An equity/tax matrix showing tax savings opposed to principle growth across a low to medium to high is also illustrated, showing a middle rating for the 30 yr. FIXED rate selected in the adjacent risk pyramid. The current statistics relate to the applicant's existing mortgage loan information, as well as a corresponding indication of the expected time in home before move or refinance. Finally, as illustrated at the bottom of the user interface, indications are provided to suggest characteristics or qualities associated with a typical or stereotypical type of borrower who would be well-suited for the selected or featured type of mortgage loan illustrated by the output of the system and method according to the present invention in a preferred embodiment. Cautionary language or indication may also be included, as shown in fine print at the bottom of the interface or output.

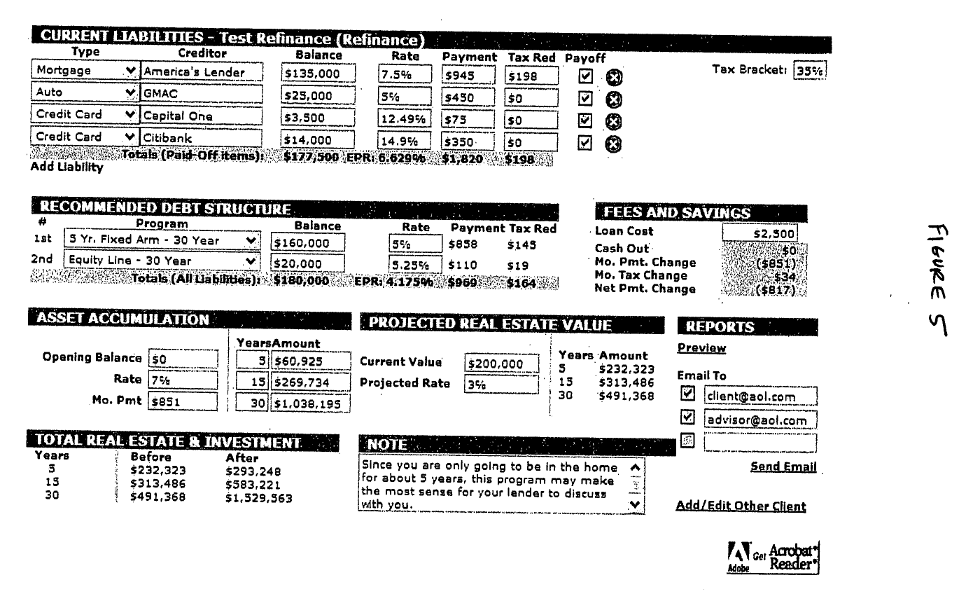

FIG. 5 is a computer screen user interface view of applicant input information prompts shown in a graphic user interface on a computer screen, according to the present invention. These inputs, which may be entered by the applicant directly or by a user other than the applicant, in coordination with the applicant in person, or based upon information provided by the applicant, include, by way of example but not limitation, a mortgage loan applicant's financial history, personal data, and status; the output information including a summary of the input information, current liabilities, recommended debt structure, asset accumulation, total real estate investment value, risk information and/or analyses, mortgage loan-related data, estimates and scenarios for mortgage loan structure, and notes.

FIG. 6 illustrates a graphic user interface according to the example set forth in the foregoing, including a partial tabular presentation of applicant-related information, including but not limited to itemization of the applicant's current liabilities, such as mortgage loan and auto loan, and revolving debt, including specific credit cards or bank cards, and their corresponding specifics, including the creditor identifier, balance, rate, payment amount, tax reduction, and whether or not a refinancing would payoff each of the liabilities indicated. A recommended debt structure, which may include at least one program, such as a mortgage loan type and an equity line type, along with the amounts corresponding to each program; fees and savings are also preferably indicated for the recommended debt structure listed on the user interface or output, as shown. Asset accumulation, projected real estate value over time, along with a total for real estate and other investment information is also shown. Significantly, FIG. 6 also provides in a preferred embodiment of the present invention a reports section, wherein the user of the system and method can select to electronically send an electronic copy of at least a portion of the mortgage loan planning analysis shown in FIGS. 1 through 6 to at least one other person or entity, preferably for use by an integrated network of service provider(s) within a predetermined community, including but not limited to bank representatives, mortgage loan lenders, investment advisors and/or stock brokers, insurance agents, tax advisors, financial planners and the like, and combinations thereof. Beneficially, the electronic, practically real-time transmittal of information from a computer-based scenario desk according to the present invention, with a display having a user interface provided thereon that is viewable by at least one user for inputting input information and reviewing output information, wherein the output information further includes diagrammatic or visual summary information relating to risk, target points, modeling, advantages/ disadvantages, and other relevant mortgage loan analyses information, so that the user(s) may collectively assist the applicant(s) with investment options provided by the community.

In a method according to the present invention, the advisor interviews the client and inputs their information into the software, where a suitability analysis and an eligibility analysis are performed to provide back the most suitable program for the consumer that they are eligible for based on their input to questions. The software outputs information, including a summary of the input information, current liabilities, recommended debt structure, asset accumulation, total real estate investment value, risk information and/or analyses, mortgage loan-related data, estimates and scenarios for mortgage loan structure, and notes; and thereby provides an integrated mortgage loan and financial planning system. The output is designed to be easy for the consumer to understand and upon their acceptance the advisor submits the client's Mortgage Plan to a lender for closing and fulfillment. The financial advisor counsels on aspects of the integration of the Mortgage Plan into the client's overall financial plan. FIG. 7 shows a questionnaire graphic user interface according to the present invention for at least one applicant or user to input information for inclusion in the system, for providing the outputs shown in the preceding FIGS. 1 through 6.

Thus, an embodiment of the present invention includes an integrated mortgage loan and financial planning system for use by an integrated network of service providers within a predetermined community, the system including at least one computer-based scenario desk with a display having an input device and user interface provided thereon that is viewable by at least one user for inputting input information and reviewing output information; the input information including a client's financial history, personal data, and status; the output information including a summary of the input information and output information selected from the group consisting of: current liabilities, recommended debt structure, asset accumulation, total real estate investment value, risk information and/or analyses, mortgage loan-related data, estimates and scenarios for mortgage loan structure, notes, and combinations thereof; thereby providing an integrated mortgage loan and financial planning system for providing investment results and options to the client.

The present invention also includes a network with network members including service providers for providing integrated mortgage loan and financial planning, the network including at least one computer-based scenario desk with a display having an input device and user interface provided thereon that is viewable by at least one user for inputting input information and reviewing output information; the input information including a client's financial history, personal data, and status; the output information including a summary of the input information and output information selected from the group consisting of: current liabilities, recommended debt structure, asset accumulation, total real estate investment value, risk information and/or analyses, mortgage loan-related data, estimates and scenarios for mortgage loan structure, notes, and combinations thereof; the at least one scenario desk user in electronic communication with the other members of the network for sharing the input and output information; thereby providing an integrated mortgage loan and financial planning network for providing investment results and options to the client.

The present invention also includes a shared, automatically-generated mortgage loan and financial planning application with a client's information for evaluation and approval by members of a network of service providers providing integrated mortgage loan and financial planning, the application including input information including the client's financial history, personal data, and status; and output information including output information selected from the group consisting of: current liabilities, recommended debt structure, asset accumulation, total real estate investment value, risk information and/or analyses, mortgage loan-related data, estimates and scenarios for mortgage loan structure, notes, and combinations thereof.

The present invention also includes a method for providing a client's integrated mortgage loan and financial planning information to a network of financial service providers, the method steps including: providing a network of at least one computer-based scenario desks with display having an input device and a user interface, viewable by at least one financial service provider, inputting information and reviewing output information; inputting information, including a mortgage loan applicant's financial history, personal data, and status; performing a suitability analysis and an eligibility analysis to find the most suitable program for which the mortgage loan applicant is eligible; outputting information, including a summary of the input information, current liabilities, recommended debt structure, asset accumulation, total real estate investment value, risk information and/or analyses, mortgage loan-related data, estimates and scenarios for mortgage loan structure, and notes; thereby providing an integrated mortgage loan and financial planning information for providing investment results and options to the client. The method can further include the step of submitting the mortgage loan plan to a lender for closing and fulfillment.

Each of these embodiments can further include output information that includes diagrammatic or visual summary information relating to mortgage loan analyses information selected from the group consisting of risk, target points, modeling, mortgage loan type advantages/disadvantages, and combinations thereof.

Certain modifications and improvements will occur to those skilled in the art upon a reading of the foregoing description. All modifications and improvements have been deleted herein for the sake of conciseness and readability but are properly within the scope of the following claims.

What is claimed is:

1) An integrated mortgage loan and financial planning system for use by an integrated network of service providers within a predetermined community, the system comprising:
at least one computer-based scenario desk with a display having an input device and user interface provided thereon that is viewable by at least one user for inputting input information and reviewing output information;
the input information including a client's financial history, personal data, and status;
the output information including a summary of the input information and output information selected from the group consisting of: current liabilities, recommended debt structure, asset accumulation, total real estate investment value, risk information and/or analyses, mortgage loan-related data, estimates and scenarios for mortgage loan structure, notes, and combinations thereof;
thereby providing an integrated mortgage loan and financial planning system for providing investment results and options to the client.

2) The system of claim 1, wherein the output information further includes diagrammatic or visual summary information relating to mortgage loan analyses information selected from the group consisting of risk, target points, modeling, mortgage loan type advantages/disadvantages, and combinations thereof.

3) A network with network members comprising service providers for providing integrated mortgage loan and financial planning, the network comprising:
at least one computer-based scenario desk with a display having an input device and user interface provided thereon that is viewable by at least one user for inputting input information and reviewing output information;
the input information including a client's financial history, personal data, and status;
the output information including a summary of the input information and output information selected from the group consisting of: current liabilities, recommended debt structure, asset accumulation, total real estate investment value, risk information and/or analyses, mortgage loan-related data, estimates and scenarios for mortgage loan structure, notes, and combinations thereof;
the at least one scenario desk user in electronic communication with the other members of the network for sharing the input and output information;
thereby providing an integrated mortgage loan and financial planning network for providing investment results and options to the client.

4) The system of claim 3, wherein the output information further includes diagrammatic or visual summary information relating to mortgage loan analyses information selected from the group consisting of risk, target points, modeling, mortgage loan type advantages/disadvantages, and combinations thereof.

5) A shared, automatically-generated mortgage loan and financial planning application with a client's information for evaluation and approval by members of a network of service providers providing integrated mortgage loan and financial planning, the application comprising:
input information including the client's financial history, personal data, and status; and
output information including output information selected from the group consisting of: current liabilities, recommended debt structure, asset accumulation, total real estate investment value, risk information and/or analyses, mortgage loan-related data, estimates and scenarios for mortgage loan structure, notes, and combinations thereof;

6) The system of claim 5, wherein the output information further includes diagrammatic or visual summary information relating to mortgage loan analyses information selected from the group consisting of risk, target points, modeling, mortgage loan type advantages/disadvantages, and combinations thereof.

7) A method for providing a client's integrated mortgage loan and financial planning information to a network of financial service providers, the method steps comprising:
providing a network of at least one computer-based scenario desks with display having an input device and a user interface, viewable by at least one financial service provider, inputting information and reviewing output information;
inputting information, including a mortgage loan applicant's financial history, personal data, and status;
performing a suitability analysis and an eligibility analysis to find the most suitable program for which the mortgage loan applicant is eligible;
outputting information, including a summary of the input information, current liabilities, recommended debt structure, asset accumulation, total real estate investment value, risk information and/or analyses, mortgage loan-related data, estimates and scenarios for mortgage loan structure, and notes;
thereby providing an integrated mortgage loan and financial planning information for providing investment results and options to the client.

8) The method of claim 7, further including the step of submitting the mortgage loan plan to a lender for closing and fulfillment.

9) The method of claim 7, wherein the output information further includes diagrammatic or visual summary information relating to mortgage loan analyses information selected from the group consisting of risk, target points, modeling, mortgage loan type advantages/disadvantages, and combinations thereof.
